(19) United States
(12) Patent Application Publication
(10) Pub. No.: US 2016/0050880 A1
(43) Pub. Date: Feb. 25, 2016

(54) MINK SLURRY HANDLING SYSTEM AND A METHOD FOR REDUCING GASEOUS EMISSION FROM A MINK FARM

(71) Applicant: JØRGEN HYLDGAARD STALDSERVICE, Holstebro (DK)

(72) Inventor: Ken HYLDGAARD, Holstebro (DK)

(21) Appl. No.: 14/779,530

(22) PCT Filed: Apr. 2, 2014
(86) PCT No.: PCT/DK2014/050077

§ 371 Date: Sep. 23, 2015

(30) Foreign Application Priority Data
Apr. 25, 2013 (DK) PA 2013 70229

(51) Int. Cl. A01K 1/01; C02F 11/00

(52) U.S. Cl. CPC A01K 1/0107; C02F 11/00; A01K 1/0103; C02F 2303/02; C02F 2103/20

(57) ABSTRACT

Disclosed is a mink slurry handling system (1) comprising a first collection tray (2) comprising a first tray inlet (3) at one end and a first tray outlet (4) at the other end, where the first collection tray (2) is arranged to extend beneath a first group (5) of mink cages (9) arranged substantially side by side. The mink slurry handling system (1) also includes a second collection tray (19) comprising a second tray inlet (6) at one end and a second tray outlet (7) at the other end, where the second collection tray (19) is arranged to extend beneath a second group (8) of mink cages (9) arranged substantially side by side and the handling system (1) includes a slurry acidification facility (10) comprising a slurry inlet (11) for leading a slurry mixture into the slurry acidification facility (10) and a slurry outlet (12) for leading acidified mink slurry out of the slurry acidification facility (10), wherein the first tray inlet (3) is connected to the second tray outlet (7), wherein the first tray outlet (4) is connected to the slurry inlet (11) either directly or through further collection trays and wherein the second tray inlet (6) is connected to the slurry outlet (12) either directly or through further collection trays. A method for reducing gaseous emission from a mink farm (18) is also disclosed.

### FIELD OF THE INVENTION

The present invention relates to a mink slurry handling system and a method for reducing gaseous emission from a mink farm comprising collection trays arranged beneath mink cages to collect urine and excrements from mink in the cages.

### BACKGROUND OF THE INVENTION

Mink farms are typically open structures in which long rows of mink cages are arranged under a roof construction. The cages are typically made from wire mesh so that urine and excrements from the caged animals falls down through the mesh in the bottom of the cage.

Thus, it is known to arrange a gutter under the rear part of the cage to collect at least some of the urine and excrements from the caged animals. But while slurry builds up in the gutter, the slurry will emit gasses such as ammonia which can be damaging to the health of the farmer, the animals and more profound the environment. Furthermore, if these mink excrements are left to dry in the gutter they will become stuck to the gutter and be very difficult to remove. It is therefore important that the gutters are emptied and scraped regularly.

From DK 177234 B1 it is therefore known to provide the gutter with a motorised scraping device. However, such devices are expensive and prone to breakdowns. And even if the device runs very often it will still only reduce the overall ammonia emission marginally.

It is therefore an object of the present invention to provide an advantageous technique for reducing emission of harmful gasses from a mink farm.

### THE INVENTION

The invention relates to a mink slurry handling system comprising a first collection tray comprising a first tray inlet at one end and a first tray outlet at the other end, where the first collection tray is arranged to extend beneath a first group of mink cages arranged substantially side by side. The mink slurry handling system also includes a second collection tray comprising a second tray inlet at one end and a second tray outlet at the other end, where the second collection tray is arranged to extend beneath a second group of mink cages arranged substantially side by side and the handling system includes a slurry acidification facility comprising a slurry inlet for leading a slurry mixture into the slurry acidification facility and a slurry outlet for leading acidified mink slurry out of the slurry acidification facility, wherein the first tray inlet is connected to the second tray outlet, wherein the first tray outlet is connected to the slurry inlet either directly or through further collection trays and wherein the second tray inlet is connected to the slurry outlet either directly or through further collection trays.

Making the mink slurry handling system comprise several collection trays coupled in series enables that a number of individual puddles of acidified slurry can be established under the cages. This is advantageous in that it is much easier to level out a number of smaller trays than to level out one single large tray so that the trays may be filled with acidified mink slurry and thereby ensure that urine and excrements from the minks is contained in the acidified slurry until it all is lead to the slurry acidification facility and the trays can be refilled with acidified slurry. And in relation to mink excrements it is particularly important that they do not land on a dry part of the tray in that they will dry in and get stuck which will entail excrement build up that has to be manually removed.

Furthermore, connecting one end of the series coupled collection trays to an inlet of the slurry acidification facility and connecting the other end of the series coupled trays to an outlet of the slurry acidification facility is advantageous in that this design enables that the collected slurry easily may be guided to the slurry acidification facility and that the trays easily may be refilled with a fresh batch of acidified slurry—and it enables that acidified slurry may be circulated in the trays e.g. to clean them.

Even further, forming the collection trays so large that they may extend beneath several cages is advantageous in that this will ensure that more controlled collection of the mink's urine and excrements and it enables a more simple and efficient manufacturing and mounting process.

It should be noted that in this connection the term “tray” should be taken to mean any form of trough, gutter, trench, case, bin or similar collection device suitable for holding an amount of acidified slurry and collecting mink urine and faeces primarily falling down from above.

It should also be noted that in this connection the term “acidification” means that the pH level of the mink slurry is lowered, i.e. that the mink slurry is acidified. In this case, the mink slurry is acidified from its normal pH level (typically above 7) to a pH level of between 5 and 6 or even lower. The acidification agent itself will typically be an acid, such as sulphuric acid, nitric acid, formic acid, phosphoric acid or the like or another acidic agent suitable for lowering the pH level of the mink slurry.

In an aspect of the invention, said first tray inlet and said first tray outlet is arranged at a bottom of said first collection tray and wherein said second tray inlet and said second tray outlet is arranged at a bottom of said second collection tray.

Arranging the inlets and the outlets of the trays at the bottom of the trays is advantageous in that it enables that the trays can easily be emptied and it reduces the risk of unwanted build-up of sediments at the bottom of the trays.

In an aspect of the invention, a bottom surface of said first collection tray is sloping downwards towards said first tray inlet and said first tray outlet and wherein a bottom surface of said second collection tray is sloping downwards towards said second tray inlet and said second tray outlet.

Making at least a part of the bottom of the trays slope downwards to the inlet and the outlet is advantageous in that makes it easier to empty the trays and to flush them.

In an aspect of the invention, said first collection tray and said second collection tray each are formed so big that they substantially cover the entire bottom surface of said first group of mink cages and said second group of mink cages, respectively.

Forming the trays to large that they substantially cover the entire bottom surface of the mink cages is advantageous in that it hereby is possible to collet substantially everything falling down from the cages—whether it be faeces, urine, forage, fodder or other.

In an aspect of the invention, said system further comprises level detection means for detecting a slurry level in at least one of said first collection tray and said second collection tray.

Providing at least one tray with level detection means is advantageous in that it hereby is possible to start the emptying process when the level in one or more trays exceeds a predefined level, it is possible to detect the level in the trays when they are refilled with acidified slurry—and thus fill them to a predefined level—and/or it is possible to detect if a passage between trays is blocked e.g. if the level in one tray rises unexpectedly of disproportionate.

In an aspect of the invention, said slurry acidification facility further comprises a slurry separator for removing at least a part of the solid portion of said slurry mixture.

Removing a solid porting from the slurry is advantageous in that it enables a more efficient acidification process but more importantly because the liquid portion of the slurry is suited for forming stagnant liquid puddles in the collection trays to prevent gas emission and to prevent the mink excrements from sticking to the trays. Furthermore, the liquid portion is suited for flushing the trays to ensure that they are substantially clean and empty before a new puddle is established in the tray.

In an aspect of the invention, said first collection tray and said second collection tray are substantially identical.

Forming the collection trays identical is advantageous in that it simplifies manufacturing and succeeding logistic.

In an aspect of the invention, said first group of mink cages and said second group of mink cages each comprises between 1 and 20, preferably between 2 and 12 and most preferred between 3 and 10 mink cages.

If the collection trays each extends under too many cages it will be difficult to handle and mount the trays and if the collection trays each extends under too few cages more cages is needed which will increase cost. Thus, the present cage number ranges present an advantageous relationship between applicability and cost.

In an aspect of the invention, said first group of mink cages and said second group of mink cages comprises the same number of mink cages.

Making the trays extend under the same number of cages is advantageous in that it enables that the tray can be formed substantially identically thus reducing cost.

In an aspect of the invention, said first group of mink cages and said second group of mink cages each comprises six mink cages, thus making the trays fit most exciting mink farms.

The invention also relates to a method for reducing gaseous emission from a mink farm comprising collection trays arranged beneath mink cages to collect urine and excrements from mink in the cages. The method comprises the steps of:
blocking a flow from the collection trays to a slurry acidification facility,
providing acidified mink slurry in the collection trays from the slurry acidification facility to form a substantially stagnant puddle of the acidified mink slurry in the collection trays, and
removing the blocking of the flow from the collection trays to the slurry acidification facility to lead a slurry mixture, comprising the acidified mink slurry and collected urine and excrements, to the slurry acidification facility.

Compared to normal mink slurry the emission of environmentally damaging gasses—such as ammonia—and bad smells is drastically reduced is the slurry is acidified. Thus, forming a pool of acidified slurry under the mink cages is advantageous in that as soon as the urine and excrements—from the minks in the cages—reaches the tray it will fall into the acidified slurry, where it will be contained until the blocking is removed and the slurry mixture is lead to the slurry acidification facility.

It should also be noted that with traditional mink slurry handling methods flies are a serious problem. But maggots do not like the acid environment in the acidified slurry in the trays and this combined with regular exchange of the slurry in the trays severely reduces the problem of flies.

In an aspect of the invention, said blocking of said flow from said collection trays to said slurry acidification facility is removed after a predetermined time.

Starting the emptying process and possibly other processes such as a flushing process, a refilling process etc. in relation to time is advantageous in that the use of detection means such as level sensors, flow sensors, temperature sensors etc. hereby can be reduced or even avoided, hereby simplifying the system and reducing cost.

In an aspect of the invention, said blocking of said flow from said collection trays to said slurry acidification facility is removed in response to level detection in at least one of said collection trays, in response to pH detection of the slurry in at least one of said collection trays and/or in relation to a temperature of the surroundings or of said slurry mixture in said stagnant puddles in at least one of said collection trays.

Starting to empty the trays in response to one or more of the above mentioned methods is advantageous in that it enables better control and thus reduced gas emission and/or more efficient use of the system.

In an aspect of the invention, said method further comprises the step of flushing said collection trays by means of acidified mink slurry after said slurry mixture is lead to said slurry acidification facility.

Flushing the trays—e.g. by running liquid acidified slurry through the trays repeatedly and/or at high speed—is advantageous in that it hereby is ensured that the trays are more clean before being refilled—thus, unwanted build-up is avoided or reduced.

In an aspect of the invention, said acidified mink slurry provided to said collection trays is at least a part of said slurry mixture lead to said slurry acidification facility from said collection trays.

Filling and flushing the trays with acidified slurry that is at least a part of the collected slurry is advantageous in that the overall output of the system is reduced and by using liquid readily available, ample and free supply is ensured substantially at all times.

In an aspect of the invention, at least a part of a solid portion of said slurry mixture and/or acidified mink slurry is removed before said acidified mink slurry is lead into said collection trays.

Using substantially only the liquid portion of the slurry to establish the puddles and to flush the trays is advantageous in that hereby the risk of unwanted blocks in the system is reduced and by removing at least most of the solid portion, the “viscosity” is reduced or the slurry is at least more easy-flowing, hereby enabling better and more efficient mixing with urine and excrements in the tray, faster flow through the system and simpler and less energy consuming handling.

In an aspect of the invention, said acidified mink slurry is lead into one end of said collection trays and removed from an opposite end of said collection trays.

Leading the acidified mink slurry in at one end of the tray and out of the other is advantageous in that it hereby is possible to establish a flow through the tray which will ensure more efficient cleaning (flushing) and emptying.

In an aspect of the invention, said method is a method for reducing gaseous emission from a mink slurry handling system according to any of the previously discussed mink slurry handling systems.

### FIGURES

The invention will be explained further herein below with reference to the figures in which:

FIG. 1 shows a top view of an example of a mink slurry handling system,

FIG. 2 shows an arrangement of collection trays and mink cages, as seen from the back,

FIG. 3 shows a cross section trough a collection tray, as seen from the side,

FIG. 4 shows a first and a second collection tray, as seen in perspective, and

FIG. 5 shows a cross-sectional side view of the process tank of a mink slurry acidification facility.

### DETAILED DESCRIPTION

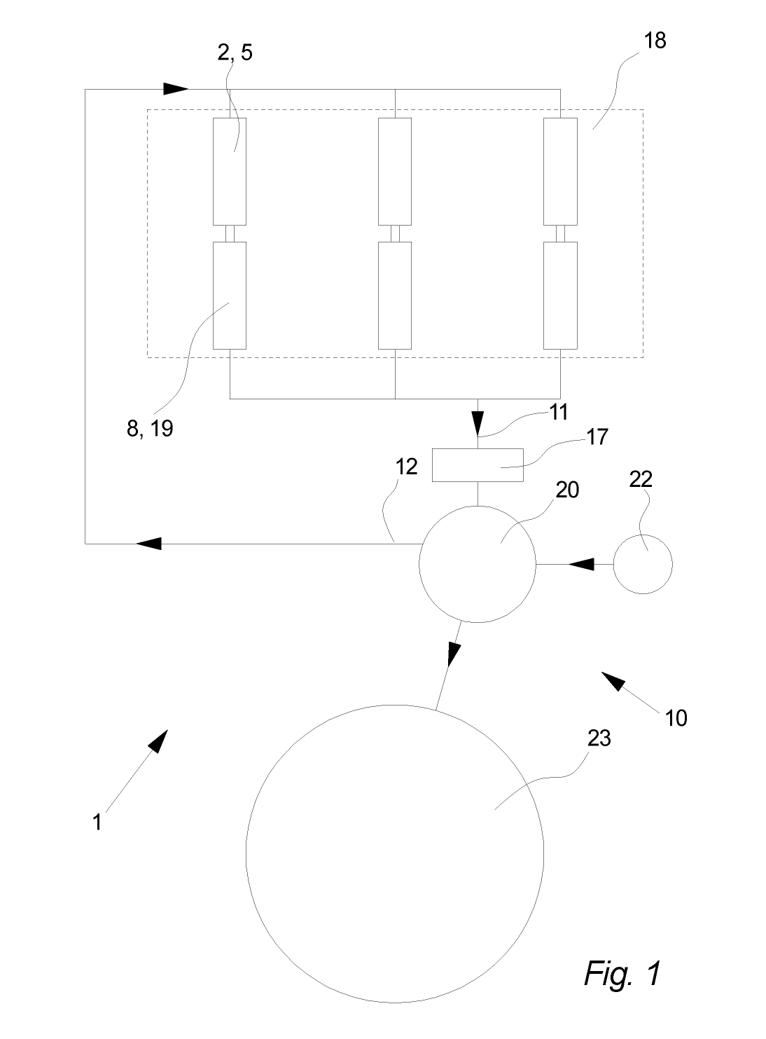

FIG. 1 shows a top view of an example of mink slurry handling system 1.

In the example shown, the mink slurry handling system 1 comprises a mink farm 18 and a slurry acidification facility 10.

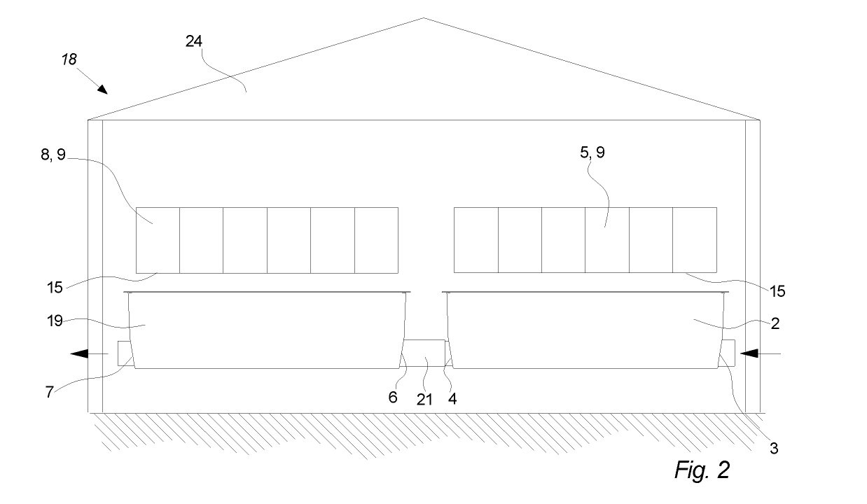

In this embodiment the farm 18 comprises three rows of mink cages 9, each comprising a first group 5 of mink cages 9 and a second group 8 of mink cages 9 underneath which first and second collection trays 2, 19 are arranged respectively—as disclosed in FIG. 2. Each row of series coupled collection trays 2, 19 is en turn connected in each end to common pipes leading to an inlet 11 and an outlet 12 of the slurry acidification facility 10.

However in another embodiment each row could comprise more than two groups 5, 8 of mink cages 9, more than two collection trays 2, 19, the farm 18 could comprise another number of rows and/or one or more of the rows could be coupled directly to the slurry acidification facility 10.

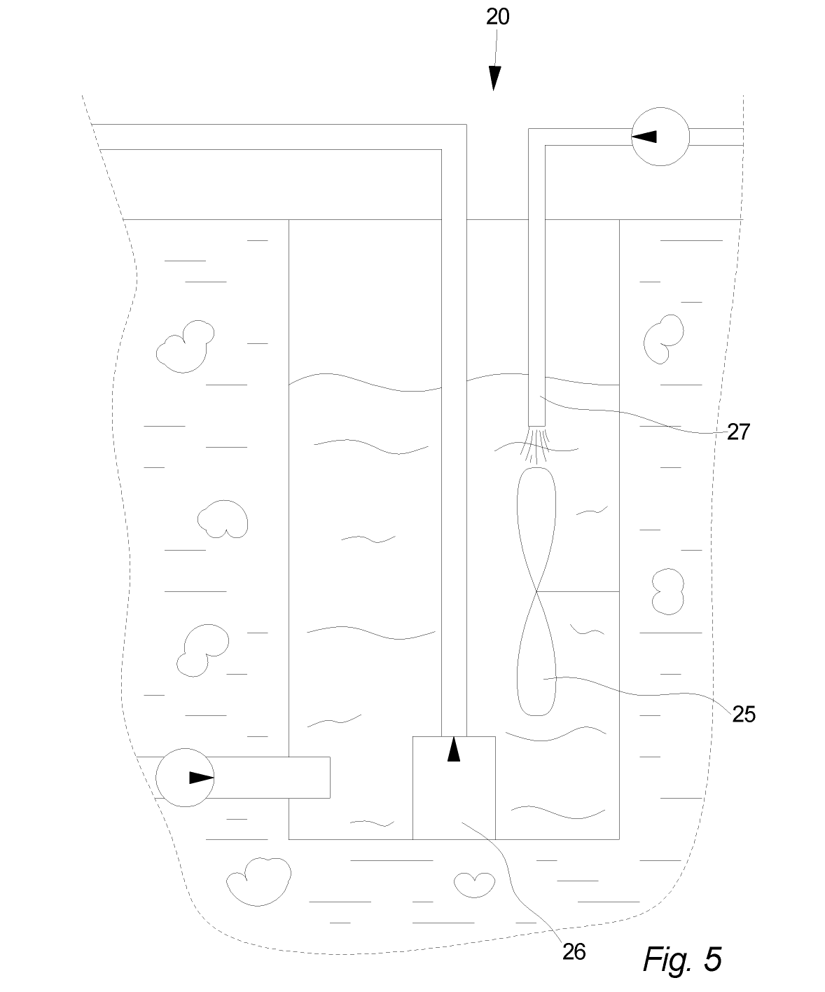

In this embodiment the slurry acidification facility 10 comprises a slurry separator 17 arranged at the slurry inlet 11 to separate solid parts of the slurry from the slurry before it is lead into a process tank 20. The process tank 20 is discussed in more details in relation with FIG. 5.

In this embodiment the slurry acidification facility 10 also comprise an acid storage for feeding acid to the slurry in the process tank 20 in an acidification process and a slurry storage 23 for holding excess slurry.

In this embodiment the mink slurry handling system 1 would operate in the following way. First the flow from the trays 2, 19 to the inlet 11 of the slurry acidification facility 10 is blocked—typically by means of an electrically operated valve—where after acidified slurry is pumped from the process tank 20 and into the trays 2, 19. This process step continues until a flow gauge registers that a specific amount of acidified slurry has been lead to the trays 2, 19. This amount is adjusted to fit the specific farm 18 so that the level of acidified slurry in the trays 2, 19 is just right.

In another embodiment one or more of the trays 2, 19 could comprise level sensors so that acidified slurry was lead to the trays 2, 19 until the level sensors detects a desired level or the pumping action could be controlled by a timer or other suitable means.

Once the trays have been filled with a desired amount of acidified slurry—i.e. once substantially stagnant puddles of acidified mink slurry has been established in the collection trays 2, 19—flow between the slurry outlet 12 of the slurry acidification facility 10 and the trays 2, 19 is also blocked—typically also by means of a valve.

For the next period of time—e.g. 2, 4, 6, 12, 18, 24, 48, 72 or more hours—the pools of acidified slurry in the trays 2, 19 is left to collect new urine and excrements from the minks in the cages 9 above.

After a predetermined period of time—or when a pH sensors detects that the pH value of the slurry mixture in the trays 2, 19 has risen to a predefined level, in response to a level sensor, in response to a temperature sensor (i.e. slurry must be changed before it freezes) or other or any combination thereof—flow is re-established from the trays 2, 19 to the slurry inlet of the slurry acidification facility 10 so that the trays 2, 19 are emptied.

In this embodiment the emptying process is immediately succeeded by a flushing process—or the flushing is started substantially simultaneously with the emptying process—in which acidified slurry from the slurry acidification facility 10 is flushed through the trays 2, 19 to flush out any sedimentation or more heavy or solid parts left in the trays 2, 19. After a predetermined period of time the flow from the trays 2, 19 to the inlet 11 of the slurry acidification facility 10 is blocked again while the pump of the slurry acidification facility 10 continues to pump “fresh” acidified slurry into the trays 2, 19 to re-establish the stagnant puddles. These steps are then repeated continuously.

In this embodiment the slurry mixture obtained from the trays 2, 19 is first guided through a slurry separator 17 which will separate most of the solid portion of the slurry mixture from the mixture before the remaining liquid portion is continued into the process tank 20. The separated solid portion can then e.g. be used a biofuel, as fertiliser or other.

Thus, in this embodiment the acidified slurry forming the pools in the trays 2, 19 is made completely from parts of the slurry mixture previously removed from the trays 2, 19 and surplus slurry is regularly lead to the slurry storage 23 from which it is removed and e.g. used as fertiliser or other. However in another embodiment the acidified slurry forming the pools in the trays 2, 19 could comprise other elements such as water, foam damping agents, means for adjusting/reducing the smell or other.

In another embodiment the mink slurry handling system 1 or particularly the slurry acidification facility 10 could comprise further tanks e.g. a temporary holding tank for containing slurry mixture from the trays 2, 19 while acidified slurry from the process tank is circulated through the trays 2, 19 to flush them, the pipework could be laid out differently e.g. to enable simpler or more efficient circulation of acidified slurry through the trays 2, 19 or for other reasons.

FIG. 2 shows an arrangement of collection trays 2, 19 and mink cages 5, 8, as seen from the back.

In this embodiment the mink cages 9 are arranged in groups 5, 8 of six but in another embodiment the groups 5, 8 could comprise another number of cages 9 such as two, three, four, eight, ten, twelve or more.

In this embodiment the trays 2, 19 is mounted on the framework (not shown) on which the cages 9 are arranged but in another embodiment the trays 2, 19 could be arranged on a separated dedicated support structure or they could be suspended from the cages 9 or the building structure 24.

Under the first group 5 of cages 9 a first collection tray 2 is arranged and under the second group 8 of cages 9 a second collection tray 19 is arranged, however in another embodiment one collection tray 2, 19 may extent under more than one group of cages 5, 8.

In this embodiment all the trays 2, 19 are identical and they are all approximately 1860 mm wide and approximately 760 mm deep to substantially cover the entire bottom surface of the respective groups 5, 8 of cages 9 but in another embodiment the trays 2, 19 would not be identical e.g. to adapt to groups 5, 8 or cages 9 of different sizes, the trays 2 could be form larger or smaller e.g. to adapt to other cage 9 or group 5, 8 sizes or to e.g. only cover parts of the bottom surface of the cages 9.

A mink farm 18 is typically an open structure where the cages 9 are merely covered by a roof structure 24 leaving the walls open. Thus, the mink slurry handling system land particularly the slurry collecting and removing means must be able to withstand the fury of the elements even in the hard northern climate where mink typically is raised.

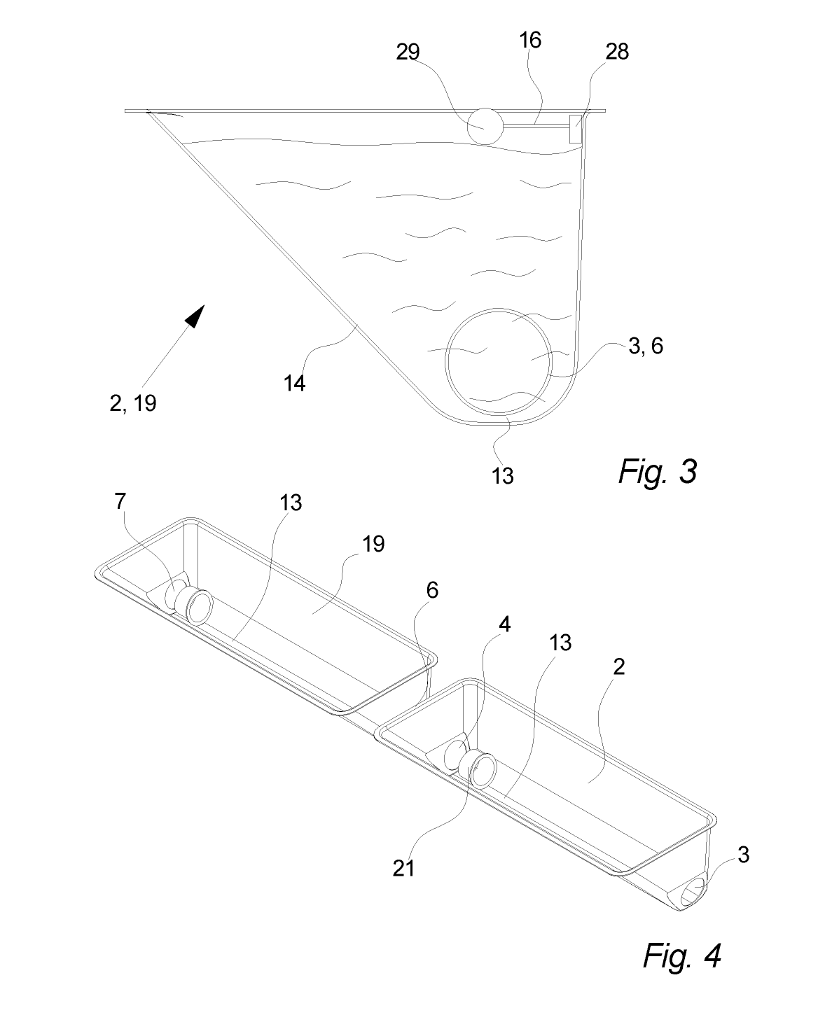

FIG. 3 shows a cross section trough a collection tray 2, 19, as seen from the side.

In this embodiment the tray 2, 19 is filled with acidified slurry so that the tray 2, 19 is almost full. Ammonia evaporation is significantly lowered in acidified slurry compared to regular slurry and acidified slurry does not smell nearly as bad as regular slurry. Furthermore, fly maggots does not thrive in acidified slurry (particularly not since it is exchanged regularly).

Thus, the stagnant pools of acidified slurry in the trays 2, 19 are very well suited for collecting and containing the new urine and excrements from the minks and before the pH level exceeds a specific level (e.g. after a specific amount of time based on an empiric study) the slurry mixture is removed and replaced with a fresh batch of acidified slurry.

In this embodiment the tray inlet 3, 6 (and the tray outlet 4, 7—not shown) is arranged at the bottom 13 of the tray 2, 19 to ensure that it is easy to flush sediments, residue, dross and similar out of the trays 2, 19. However, in another embodiment each tray 2, 19 could comprise more than one tray inlet 3, 6 and tray outlet 4, 7 and one or more of these could be arranged differently in the trays 2, 19 e.g. to flush particularly exposed areas or other.

In this embodiment a bottom surface 14 of one side of the bottom 13 of the tray 2, 19 slopes downwards towards the inlet 3, 6 and outlet 4, 7 but in another embodiment both sides of the bottom surface 14 could slope towards the inlet 3, 6 and outlet 4, 7, the bottom 13 could be substantially flat, the bottom surface 14 or parts of the bottom surface 14 could be shaped as an arc or a curve, the bottom 13 could comprise more than one channels e.g. corresponding to more than one inlet 3, 6 and outlet 4, 7 or any combination thereof.

In this embodiment the tray 2, 19 is provided with level detection means 16 in the form of a mechanical switch 28 connected to a buoyant element 29 to detect is a specific level has been reached or exceeded. The level detection means 16 could e.g. be placed in the first collection tray 2 so that the means 16 also would detect if a passage between the first tray 2 and the second tray 19 or the passage between the second tray 19 and further trays was blocked when acidified slurry is lead into the series coupled trays 2, 19.

In another embodiment one or more of the trays 2, 19 are also provided with other sensors (not shown) such as temperature sensors, pH sensors or other.

FIG. 4 shows a first and a second collection tray 2, 19, as seen in perspective.

In this embodiment the first tray inlet 3, the first tray outlet 4, the second tray inlet 6 and the second tray outlet 7 are all substantially aligned—i.e. in this case they are of substantially similar size and coaxially arranged—to reduce resistance and thus ensure that it is possible to establish a suitable flow through the trays 2, 19 when they are flushed.

In this embodiment the inlet 3, 6 and the outlet 4, 7 of the collection trays 2, 19 are provided with corresponding tray pipes 21 to establish fluid communication between the trays 2, 9. In this embodiment the pipes 21 are welded to each other and to the respective trays 2, 19 but in another embodiment they could be connected to each other and/or the trays 2, 19 by means of adhesive, adhesive tape, soldering, rivets, bolts or other or the tray pipes 21 could be formed integrally with each other and/or the trays 2, 19 or similar.

FIG. 5 shows a cross-sectional side view of the process tank 20 of a mink slurry acidification facility 10.

In this embodiment the process tank 20 is arranged sub-surface but in another embodiment the tank 20 or at least parts of the tank 20 would be arranged above ground.

In this embodiment the process tank 20 is provided with a mixing unit 25 in the form of a propeller agitator but in another embodiment the mixing unit 25 could be constructed as a whisk, mixing paddles, nozzles creating high velocity circulation in the slurry, a unit for shaking or rotating the entire process tank 20 or it could be any other unit suitable for ensuring that the acidification agent is quickly and efficiently distributed in slurry.

In the example shown, the slurry mixture is conveyed from the trays 2, 19 in the mink farm 18 to the process tank 20 by a pump. Each time the slurry in the trays 2, 19 is changed or when a desired level of slurry mixture has been reached in the process tank 2 the acidification process is started.

In the acidification process the acidification agent is added to the mink slurry mixture in the process tank 20 during agitation by the mixing unit 25.

The quantity of acidification agent added to the mink slurry can be determined based on a pH measurement of the slurry in the process tank 20 or a preceding measurement of the pH value for the slurry in the mink farm 18 from which said quantity of slurry is obtained. Alternatively, a fixed quantity of acidification agent could be added to a fixed quantity of slurry or the quantity of acidification agent can be determined in another way.

When the acidification agent has been thoroughly mixed with the slurry, the acidified slurry is ready to be returned to the trays 2, 19 in the mink farm 18 by the return means 26 which in this case is a submerged pump placed at the bottom of the process tank 20. Via pipes connected to the submerged pump 26, at least a portion of the acidified slurry is pumped up of the process tank 20 and into the trays 2, 19 in the mink farm 18. The submerged pump 26 could possibly also be used to convey a portion of the acidified mink slurry into a storage tank 23, or the process tank 20 could be provided with a separate pump for this purpose.

One aspect of the invention is that the acidification agent is sulphuric acid.

Sulphuric acid is relatively cheap and suitable for acidifying mink slurry. As sulphuric acid at the same time has a density of 1.8 g/cm³ making it heavier than the mink slurry, it is particularly suitable as acidification agent in connection with an acidification facility 10 wherein the acidification agent is added to the top of the mink slurry trough an acid outlet 27 leading the acidification agent from the acid storage 22 to the process tank 20.

In the foregoing, the invention is described in relation to specific embodiments of Mink slurry handling systems 1, collection trays 2, 19, slurry acidification facilities 10 etc. as shown in the drawings, but it is readily understood by a person skilled in the art that the invention can be varied in numerous ways within the scope of the appended claims.

### LIST

1. Mink slurry handling system
2. First collection tray
3. First tray inlet
4. First tray outlet
5. First group of mink cages
6. Second tray inlet
7. Second tray outlet
8. Second group of mink cages
9. Mink cage
10. Slurry acidification facility
11. Slurry inlet
12. Slurry outlet
13. Bottom of collection tray
14. Bottom surface
15. Cage bottom surface
16. Level detection means
17. Slurry separator
18. Mink farm
19. Second collection tray
20. Process tank
21. Tray pipe
22. Acid storage
23. Slurry storage
24. Roof structure
25. Mixing unit
26. Return means
27. Acid outlet
28. Mechanical switch
29. Buoyant element

1. A mink slurry handling system comprising
a first collection tray comprising a first tray inlet at one end and a first tray outlet at the other end, said first collection tray being arranged to extend beneath a first group of mink cages arranged substantially side by side,
a second collection tray comprising, a second tray inlet at one end and a second tray outlet at the other end, said second collection tray being arranged to extend beneath a second group of mink cages arranged substantially side by side,
a slurry acidification facility comprising a slurry inlet for leading a slurry mixture into said slurry acidification facility and a slurry outlet for leading acidified mink slurry out of said slurry acidification facility,
wherein said first tray inlet is connected to said second tray outlet, wherein said first tray outlet is connected to said slurry inlet either directly or through further collection trays and wherein said second tray inlet is connected to said slurry outlet either directly or through further collection trays.

2. A mink slurry handling system according to claim 1, wherein said first tray inlet and said first tray outlet is arranged at a bottom of said first collection tray and wherein said second tray inlet and said second tray outlet is arranged at a bottom of said second collection tray.

3. A mink slurry handling system according to claim 1, wherein a bottom surface of said first collection tray is sloping downwards towards said first tray inlet and said first tray outlet and wherein a bottom surface of said second collection tray is sloping downwards towards said second tray inlet and said second tray outlet.

4. A mink slurry handling system according to claim 1, wherein said first collection tray and said second collection tray each are formed so big that they substantially cover the entire cage bottom surface of said first group of mink cages and said second group of mink cages, respectively.

5. A mink slurry handling system according to claim 1, wherein said system further comprises level detection means for detecting a slurry level in at least one of said first collection tray and said second collection tray.

6. A mink slurry handling system according to claim 1, wherein said slurry acidification facility further comprises a slurry separator for removing at least a part of the solid portion of said slurry mixture.

7. A mink slurry handling system according to claim 1, wherein said first collection tray and said second collection tray are substantially identical.

8. A mink slurry handling system according to claim 1, wherein said first group of mink cages and said second group of mink cages each comprises between 1 and 20, preferably between 2 and 12 and most preferred between 3 and 10 mink cages.

9. A mink slurry handling system according to claim 1, wherein said first group of mink cages and said second group of mink cages comprises the same number of mink cages.

10. A mink slurry handling system according to claim 1, wherein said first group of mink cages and said second group of mink cages each comprises six mink cages.

11. A method for reducing gaseous emission from a mink farm, said mink farm comprising collection trays arranged beneath mink cages (9) to collect urine and excrements from mink in said cages, wherein said method comprises the steps of:
blocking a flow from said collection trays to a slurry acidification facility,
providing acidified mink slurry in said collection trays from said slurry acidification facility to form a substantially stagnant puddle of said acidified mink slurry in said collection trays, and
removing said blocking of said flow from said collection trays to said slurry acidification facility to lead a slurry mixture, comprising said acidified mink slurry and collected urine and excrements, to said slurry acidification facility.

12. A method according to claim 11, wherein said blocking of said flow from said collection trays to said slurry acidification facility is removed after a predetermined time.

13. A method according to claim 11, wherein said blocking of said flow from said collection trays to said slurry acidification facility is removed in response to level detection in at least one of said collection trays, in response to pH detection of the slurry in at least one of said collection trays and/or in relation to a temperature of the surroundings or of said slurry mixture in said stagnant puddles in at least one of said collection trays.

14. A method according to claim 11, wherein said method further comprises the step of flushing said collection trays by means of acidified mink slurry after said slurry mixture is lead to said slurry acidification facility.

15. A method according to claim 11, wherein said acidified mink slurry provided to said collection trays is at least a part of said slurry mixture lead to said slurry acidification facility from said collection trays.

16. A method according to claim 15, wherein at least a part of a solid portion of said slurry mixture and/or acidified mink slurry is removed before said acidified mink slurry is lead into said collection trays.

17. A method according to claim 11, wherein said acidified mink slurry is lead into one end of said collection trays and removed from an opposite end of said collection trays.

18. A method according to claim 11, wherein said method is a method for reducing gaseous emission from a mink slurry handling system.
